(19) United States
(12) Patent Application Publication
(10) Pub. No.: US 2012/0183681 A1
(43) Pub. Date: Jul. 19, 2012

(54) APPLICATION APPARATUS AND APPLICATION METHOD

(76) Inventor: Masakazu Umebara, Toyota-shi (JP)

(21) Appl. No.: 12/812,281

(22) PCT Filed: Mar. 3, 2009
(86) PCT No.: PCT/JP2009/053941

§ 371 Date: Jul. 9, 2010

(30) Foreign Application Priority Data
Apr. 7, 2008 (JP) 2008-098920

(51) Int. Cl. H01M 4/64; B05C 1/00; B05C 5/00

(52) U.S. Cl. 427/113; 118/300; 118/200; 427/58; 118/255

(57) ABSTRACT

Before the application of a liquid application agent to a base material having at least an outer surface of uneven shape, a low-viscosity liquid having a lower viscosity than that of the application agent is applied to a region of the base material, the application agent being supposed to be applied to the region. The low-viscosity liquid is preferably a liquid having compatibility with the application agent.

### TECHNICAL FIELD

The present invention relates to an application apparatus and an application method for use in applying an application agent at least to a base material having an outer surface of uneven shape.

### BACKGROUND ART

Conventionally, gravure rolls, spray application apparatuses or the like have been used to apply a liquid application agent to a base material (see, for example, Patent Documents 1 and 2). The application processing is used, for example, in manufacturing electrodes of secondary batteries. Specifically, a material (such as an active material) for forming an electrode layer is applied as an application agent to a collector as a base material.

[Patent Document 1] Japanese Patent Laid-Open No. 2007-273126

[Patent Document 2] Japanese Patent Laid-Open No. 2007-112140

### DISCLOSURE OF THE INVENTION

### Problems to be Solved by the Invention

When the base material is made of a porous material and the application agent is applied to the base material, however, bubble marks may remain inside or on an outer surface of the layer of the application agent. If such bubble marks are produced, the base material having the application agent applied thereto may not be usable as a product. Especially when the base material having the application agent applied thereto is used as an electrode of a secondary battery, the properties of the resulting secondary battery may be adversely affected.

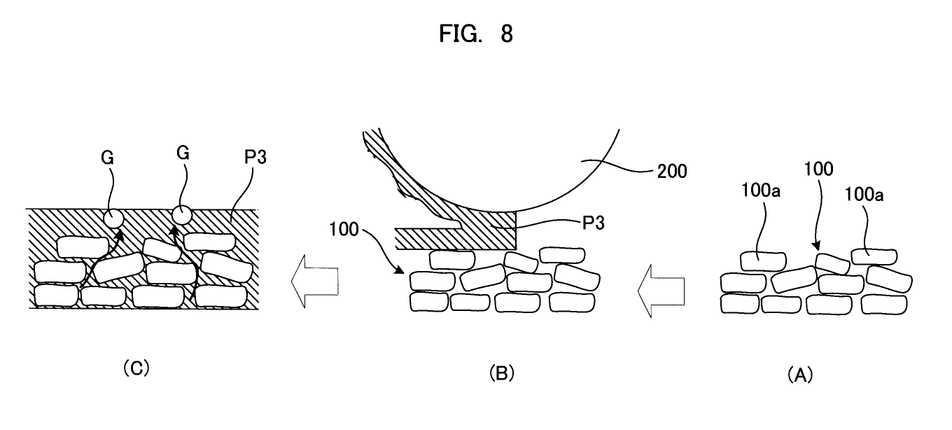

In the following, the principle of the production of the bubble marks is described with reference to FIG. 8. FIG. 8 (section A to C) shows steps of applying a liquid application agent P3 to a porous base material 100 by using a roll 200.

FIG. 8 (section A) is a schematic diagram showing the inner structure of the porous base material 100 before the application of the application agent P3. As shown in FIG. 8 (section A), the base material 100 is formed of a plurality of particles 100a and contains space formed between the particles 100a. Air is present in the space. When the application agent P3 is applied to the base material 100 with the roll 200 as shown in FIG. 8 (section B), the application agent P3 enters from the outer surface toward the interior of the base material 100.

When the application agent P3 enters into the interior from the outer surface of the base material 100, the air present inside the base material 100 passes through between the particles 100a in the base material 100 toward the outside of the application agent P3 as shown by arrows in FIG. 8 (section C). In other words, the air present inside the base material 100 moves in the direction opposite to the direction in which the application agent enters.

At this point, not all the air present inside the base material 100 comes out. In other words, bubbles G may remain inside or on the outer surface of the application agent P3. This produces bubble marks. In some cases, the base material 100 having the application agent P3 applied thereto is subjected to dry processing with a drying furnace, and after the base material 100 is dried, the bubbles G may remain as the bubble marks.

It is thus an object of the present invention to provide an application apparatus and an application method capable of preventing production of bubble marks.

### Means for Solving the Problems

An application apparatus according to a first invention in which, before a liquid application agent is applied to a base material having at least an outer surface of uneven shape, a low-viscosity liquid having a lower viscosity than that of the application agent is applied to a region of the base material, the application agent being supposed to be applied to the region.

An application method according to a second invention comprises a first step of applying an application agent to a base material having at least an outer surface of uneven shape; and a second step of applying a low-viscosity liquid having a lower viscosity than that of the application agent to a region of the base material before the first step, the application agent being supposed to be applied to the region.

A structure applying the low-viscosity liquid to the base material can have an accommodating member configured to accommodate the low-viscosity liquid; and a roll member configured to apply the low-viscosity liquid in the accommodating member to the base material through rotation operation. A spray unit can be used to spray the low-viscosity liquid to the base material. A structure applying the application agent to the base material can have an accommodating member configured to accommodate the application agent; and a roll member configured to apply the application agent in the accommodating member to the base material through rotation operation.

The low-viscosity liquid is preferably a liquid having compatibility with the application agent. This can prevent separation between the low-viscosity liquid and the application agent even when the application agent is applied to the region having the low-viscosity liquid applied thereto. The amount of the low-viscosity liquid applied to the base material is preferably equal to or larger than an amount which fills a space portion included in the base material. This can prevent air or the like from remaining inside the base material, so that the production of bubble marks can be prevented even when the application agent is applied.

A porous substance can be used as the base material. Since bubble marks are easily produced when the base material of the porous substance is used, the present invention can be used preferably.

The application apparatus and the application method of the present invention described above can be used for manufacturing an electrode of a secondary battery (such as a lithium-ion battery), for example. More specifically, the present invention can be used in applying a material (such as an active material) forming an electrode layer as an application agent to a collector as a base material.

### EFFECT OF THE INVENTION

According to the present invention, since the low-viscosity liquid having the lower viscosity than that of the application agent is applied to the base material before the application of the application agent to the base material, bubbles produced from the base material can be removed and then the application agent can be applied, thereby preventing the production of bubble marks. The application of the low-viscosity liquid having the lower viscosity than that of the application agent to the base material causes the bubbles to come out of the layer of the low-viscosity liquid and the base material easily. Then, the application agent is applied with the bubbles removed, so that bubbles are not produced newly from the base material and the production of bubble marks can be prevented.

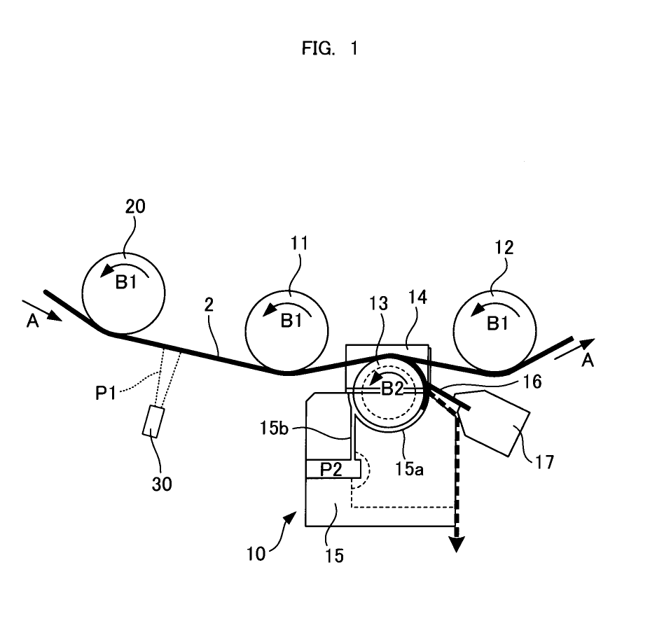

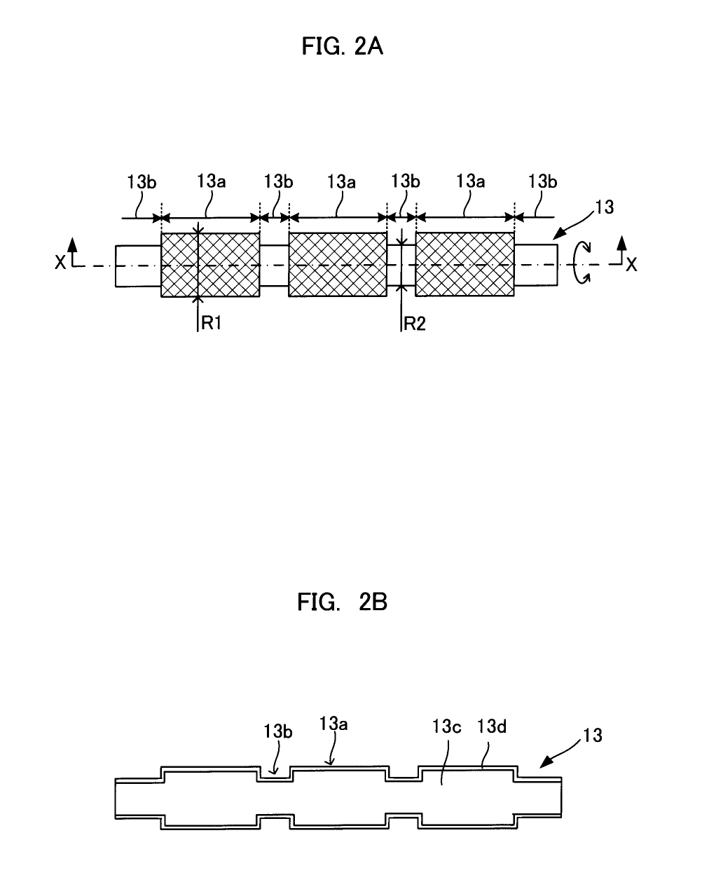

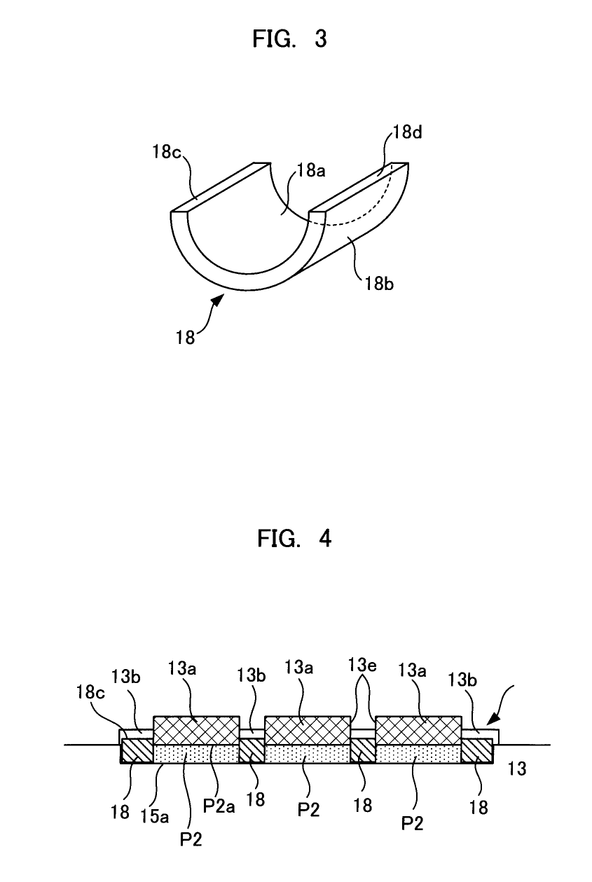

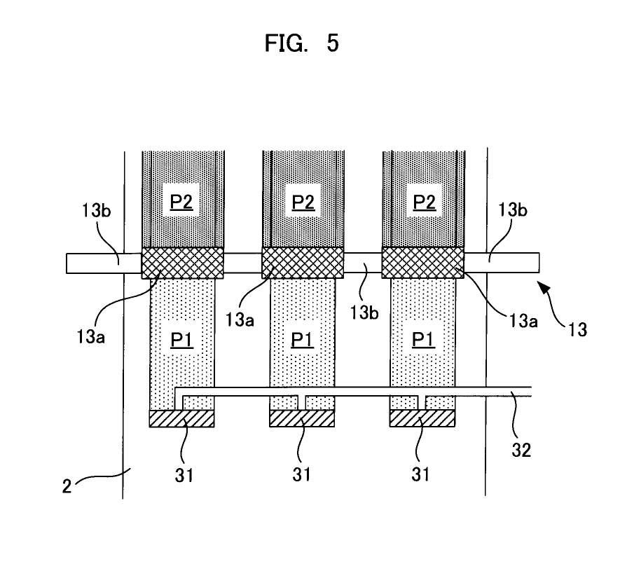

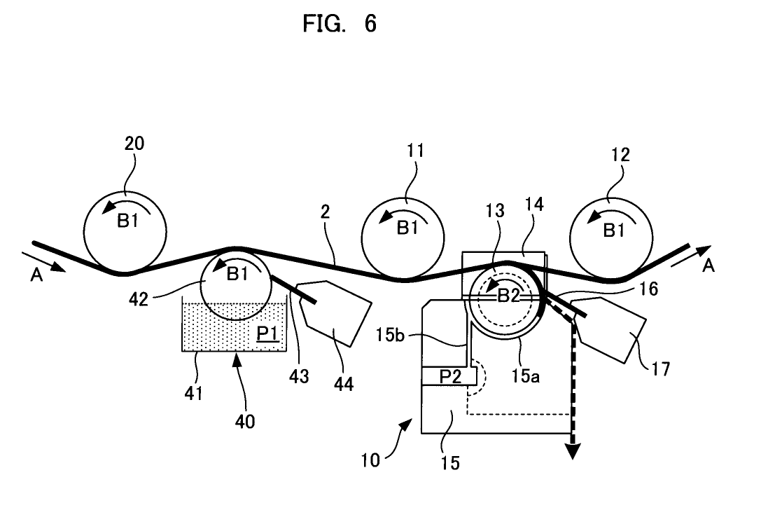

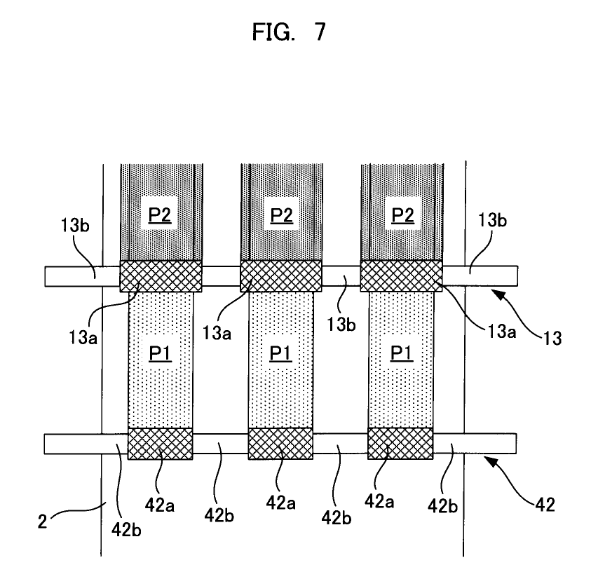

### BRIEF DESCRIPTION OF DRAWINGS

[FIG. 1] A schematic diagram showing the structure of an application apparatus which is Embodiment 1 of the present invention.

[FIG. 2A] A side view showing a gravure roll.

[FIG. 2B] A section view showing the gravure roll.

[FIG. 3] A perspective view showing the outer appearance of a cover member for use in a gravure application apparatus.

[FIG. 4] A schematic diagram showing the internal structure of the gravure application apparatus.

[FIG. 5] A diagram showing application steps of a solvent and an application agent in Embodiment 1.

[FIG. 6] A schematic diagram showing the structure of an application apparatus which is Embodiment 2 of the present invention.

[FIG. 7] A diagram showing application steps of a solvent and an application agent in Embodiment 2.

[FIG. 8] Diagrams (A to C) for explaining the phenomenon in which bubble marks are produced.

### EMBODIMENT OF THE INVENTION

Preferred embodiments of the present invention will hereinafter be described.

### Embodiment 1

An application apparatus which is Embodiment 1 of the present invention will be described with reference to FIG. 1. FIG. 1 is a schematic diagram showing the structure of the application apparatus.

A base material 2 is unreeled from sheet roll (not shown) and is supplied with a tension by stretch rolls 20, 11, and 12. The stretch rolls 20, 11, and 12 are rotated in a direction (counterclockwise direction) shown by arrows B1 in FIG. 1 to carry the base material 2 in a direction shown by an arrow A. The base material 2 is fed from the stretch roll 12, subjected to dry processing in a drying furnace, and then reeled on a take-up roll (not shown).

A gravure application apparatus 10 is placed on the opposite side of the base material 2 to the side of the stretch rolls 11 and 12. First, the structure of the gravure application apparatus 10 will be described.

A gravure roll (roll member) 13 is in contact with the area of the base material 2 that is placed between the stretch rolls 11 and 12. The gravure roll 13 is rotatably supported by a support mechanism 14. The stretch rolls 11 and 12 can be moved in a vertical direction in FIG. 1, and the movement amount thereof is adjusted to allow the adjustment of the contact pressure of the gravure roll 13 to the base material 2.

The gravure roll 13 is connected to an actuator via a power transmission mechanism (not shown) and is rotated in response to drive force from the actuator. As shown by an arrow B2 in FIG. 1, the gravure roll 13 is rotated in the direction (in other words, the counterclockwise direction in FIG. 1) opposite to the carry direction of the base material 2. Alternatively, the gravure roll 13 can be rotated in the same direction as the carry direction of the base material 2.

An application agent P2 is supplied to the gravure roll 13 from an application agent supplier 15. The application agent P2 is a solution which contains a solute and a dissolvent.

The application agent supplier 15 has a concave accommodating portion 15a for accommodating the application agent P2. The accommodating portion 15a is formed to have a shape conforming to the outer periphery of the gravure roll 13 (a shape having a curvature), and part of the gravure roll 13 is located in the accommodating portion 15a. Specifically, substantially half the gravure roll 13 is located in the accommodating portion 15a.

The accommodating portion 15a is connected to a supply source (not shown) of the application agent P2 via a supply path 15b provided for the application agent supplier 15. Thus, the application agent P2 supplied from the supply source is directed to the accommodating portion 15a via the supply path 15b. The application agent P2 is supplied from the supply source at all times, and the application agent P2 supplied to the accommodating portion 15a then flows out of the accommodating portion 15a and is discharged to the outside of the application agent supplier 15 as shown by an arrow of dotted line in FIG. 1.

The application agent P2 spilled from the accommodating portion 15a is then recovered in a recovery container (not shown) placed below the application agent supplier 15 and is returned to the supply source. In this manner, the application agent P2 is circulated through the supply source and the application agent supplier 15.

The structure for supplying the application agent P2 to the gravure roll 13 is not limited to the structure of the application agent supplier 15 described in the present embodiment. Specifically, any structure can be used as long as an accommodating member is provided for accommodating the application agent P2 and the gravure roll 13 is brought into contact with the application agent P2 within the accommodating member.

A doctor blade 16 is in contact with an outer surface of the gravure roll 13. The doctor blade 16 has the functions of wiping away any excess application agent P2 adhering to the outer surface of the gravure roll 13 and of placing the application agent P2 substantially uniformly onto a gravure pattern (carving portion) formed on the outer surface of the gravure roll 13.

The doctor blade 16 is made of resin such as plastic and rubber and is held on a holder 17.

Next, the specific structure of the gravure roll 13 will be described with reference to FIGS. 2A and 2B. FIG. 2A is a side view showing the gravure roll 13 when it is viewed from the direction orthogonal to the rotational axis and FIG. 2B is a section view taken along a line X-X in FIG. 2A.

The gravure roll 13 has an application region 13a in which the gravure pattern (groove portion) is carved in a circumferential direction and a non-application region 13b in which the gravure pattern is not carved in the circumferential direction. The application agent P2 is held in the gravure pattern formed in the application region 13a. Specifically, when the gravure roll 13 is rotated, the application agent P2 adheres to the gravure pattern in the application region 13a located within the accommodating portion 15a.

When the gravure roll 13 is further rotated with the application agent P2 adhering to the application region 13a, the application region 13a holding the application agent P2 thereon is brought into contact with the base material 2 to transfer the application agent P2 on the application region 13a to the base material 2. Thus, the application of the application agent P2 to the base material 2 is performed.

An outer diameter R1 of the application region 13a is larger than an outer diameter R2 of the non-application region 13b. Each of the application regions 13a has a substantially uniform diameter over the entire region in the direction of the rotational axis. Each of the non-application regions 13b also has a substantially uniform diameter over the entire region in the direction of the rotational axis.

As shown in FIG. 2B, the gravure roll 13 is formed of a roll core 13c made of metal such as iron having rigidity and tenacity and a ceramic layer 13d formed on an outer surface of the roll core 13c and having a predetermined thickness. The ceramic layer 13d is formed by plasma-spraying ceramic powder (such as chromium oxide) to the outer surface of the roll core 13c.

The gravure pattern is formed on a region of the outer surface of the ceramic layer 13d that corresponds to the application region 13a. Specifically, after the ceramic layer 13d is formed on the outer surface of the roll core 13c, the outer surface of the ceramic layer 13d is polished and laser irradiation is performed thereon to form the gravure pattern.

The thickness of the ceramic layer 13d can be set as appropriate in view of resistance to wear and the like. The thickness of the ceramic layer 13d is larger than the depth of the groove of the gravure pattern formed in the application region 13a.

The wear of the gravure roll 13 can be reduced by forming the outer surface of the gravure roll 13 using the ceramic layer 13d and forming the doctor blade 16 of the resin material. In addition, the reduced wear of the gravure roll 13 can prevent powder caused by the wear from entering the layer (film) of the application agent P2 formed on the base material 2.

The outer diameter R1 of the application region 13a and the outer diameter R2 of the non-application region 13b of the gravure roll 13 can be set as appropriate. However, an extremely small outer diameter R2 reduces the strength of the gravure roll 13, so that the outer diameter R2 can be set within a range in which the strength is ensured. The outer diameter R1 can be set to be larger than the outer diameter R2.

While the present embodiment is described with the case where the three application regions 13a are formed in the gravure roll 13, the present invention is not limited thereto. Specifically, only one application region 13a can be formed, or a plurality of (two, or four or more) application regions 13a can be formed.

A cover member 18 shown in FIG. 3 is placed in each portion of the gravure roll 13 that corresponds to the non-application region 13b. The cover member 18 has a shape having a curvature and can be formed of Teflon® or the like. An inner circumferential surface 18a of the cover member 18 is formed to have a shape conforming to the non-application region 13b of the gravure roll 13 and is opposed to the non-application region 13b. A clearance is formed between the inner circumferential surface 18a of the cover member 18 and the non-application region 13b to ensure the rotation of the gravure roll 13.

An outer circumferential surface 18b of the cover member 18 is formed to have a shape conforming to the accommodating portion 15a of the application agent supplier 15 and is fixed to the accommodating portion 15a. The width of the cover member 18 is substantially equal to the width (length in the rotational axis direction) of the non-application region 13b.

In the state in which the cover member 18 is fixed to the accommodating portion 15a, both end portions 18c and 18d of the cover member 18 in the circumferential direction are located above a surface (in other words, a liquid level) P2a of the application agent P2 accommodated in the accommodating portion 15a as shown in FIG. 4. Thus, the cover member 18 prevents the application agent P2 from adhering to the non-application region 13b of the gravure roll 13. FIG. 4 is a schematic diagram showing the gravure roll 13, the cover member 18, and the application agent P2 located inside the accommodating portion 15a.

The application region 13a in the gravure roll 13 can be in contact with the application agent P2 accommodated in the accommodating portion 15a and the non-application region 13b can not be in contact with the application agent P2. In other words, the gravure roll 13 can be placed such that the non-application region 13b is at a position separated from the surface of the application agent P2. In a side wall surface 13e located at the border between the application region 13a and the non-application region 13b, some area is in contact with the application agent P2.

In the present embodiment, as shown in FIG. 1, a spray application apparatus 30 is used to apply (spray) a solvent P1 to the base material 2 before the gravure roll 13 is used to apply the application agent P2 to the base material 2. The base material 2 unreeled from the sheet roll (not shown) is moved along the stretch roll 20 and the stretch roll 11. The stretch roll 20 can be moved in the vertical direction in FIG. 1 and the movement amount thereof can be adjusted.

The spray application apparatus 30 sprays the solvent P1 to the base material 2 located between the stretch rolls 20 and 11. As shown in FIG. 5, the spray application apparatus 30 has a plurality of spray nozzles 31 and a supply tube 32 configured to supply the solvent P1 to each of the spray nozzles 31. The supply tube 32 is connected to a tank (not shown) containing the solvent P1 such that the solvent P1 in the tank is supplied to the spray nozzles 31. The spray application apparatus 30 is provided with as many spray nozzles 31 as the application regions 13a in the gravure roll 13.

Each of the spray nozzles 31 sprays the solvent P1 having a predetermined width (spread) to the base material 2. As shown in FIG. 5, the width of the application region of the solvent P1 (length in a horizontal direction in FIG. 5) is smaller than the width of the application region of the application agent P2. Alternatively, the width of the application region of the solvent P1 can be substantially equal to the width of the application region of the application agent P2.

The solvent P1 is a liquid with a lower viscosity (low-viscosity liquid) than that of the application agent P2. Since the application agent P2 is applied after the application step of the solvent P1, the solvent P1 preferably has compatibility with the application agent P2. This can improve the affinity of the application agent P2 for the solvent P1.

For example, when the application agent P2 contains an organic dissolvent, an organic dissolvent is preferably used for the solvent P1. The organic dissolvent of the application agent P2 and the organic dissolvent of the solvent P1 can be the same compound or can be different compounds. When the application agent P2 contains water, water is preferably used for the solvent P1.

According to the present embodiment, the application of the solvent P1 to the base material 2 before the application of the application agent P2 to the base material 2 can prevent bubble marks from remaining inside or on the outer surface of the layer of the application agent P2 applied to the base material 2. The details thereof will hereinafter be described specifically.

When the solvent P1 is applied to the porous base material 2, the solvent P1 enters the interior of the base material 2 similarly to the case described in FIG. 8. At this point, the entry of the solvent P1 causes the air present inside the base material 2 to move in the direction opposite to the gravity direction toward the outside. Since the solvent P1 with the viscosity lower than that of the application agent P2 is applied to the base material 2 in the present embodiment, the air present inside the base material 2 comes out easily. This reduces bubbles remaining inside the base material 2 or in the layer of the solvent P1.

Then, the application agent P2 is applied to the base material 2 having the solvent P1 applied thereto. Since the air present inside the base material 2 has already come out of the base material 2 due to the solvent P1, the application of the application agent P2 does not produce bubbles. In this manner, the production of bubble marks can be suppressed in the base material 2 having the application agent P2 applied thereto.

In the present embodiment, the application amount of the solvent P1 can be set in view of the porosity in the porous base material 2. Specifically, when the space present inside the base material 2 is filled with the solvent P1, the air present inside the base material 2 can be caused to come out completely. Therefore, the application amount of the solvent P1 is preferably set to be equal to or larger than the amount corresponding to the porosity in the base material 2.

The base material 2 having the solvent P1 and the application agent P2 applied thereto is carried to the drying furnace and subjected to dry processing. At this point, the solvent P1 and the solvent (dissolvent)) contained in the application agent P2 are vaporized through the dry processing. After passing through the drying furnace, the base material 2 is cut into individual regions in which the application agent P2 is applied, and then the regions are reeled as products. If the application agent P2 is applied to one region in the base material 2, the base material 2 can not be cut and can be reeled as a product in the state after the passage through the drying furnace.

The application apparatus in the present embodiment can be used to manufacture electrodes of secondary batteries such as lithium-ion batteries, for example. Specifically, the application apparatus is used in applying a material (corresponding to the application agent P2) for forming an electrode layer to a collector as the base material 2.

Copper or aluminum can be used as the collector, for example. Materials for forming the electrode layer include, for example, an active material depending on a positive electrode layer or a negative electrode layer, a binder for binding the active material, and a dissolvent for dissolving the active material and the binder. Examples of the dissolvent include an organic dissolvent such as N-methylpyrrolidone (NMP), methylethylketone (MEK), and cyclohexanone, and water. In this case, as the solvent P1, a liquid having compatibility with an organic dissolvent or water can be used as described above.

The application apparatus according to the present invention can be used in the case where a collector having an electrode layer formed thereon is formed as the base material 2 and an inorganic oxide (corresponding to the application agent P2) is applied onto the electrode layer in order to prevent an inner short circuit of the battery. Examples of the inorganic oxide include Al₂O₃, MgO, SiO₂ and the like. An example of the electrode layer to which the inorganic oxide is applied is a layer (a negative electrode layer) formed of carbon or the like.

In applying the solvent P1 before the application of the application agent P2 containing the inorganic oxide to the collector having the electrode layer formed thereon, the width of the application of the solvent P1 needs to be substantially equal to the width of the electrode layer. This is because, if the width of the application of the solvent P1 is larger than the width of the electrode layer, the solvent P1 extending off the electrode layer is spread over the collector.

The application apparatus of the present embodiment is not used only for manufacturing the electrode of the secondary battery, and can be utilized for anything as long as the liquid application agent P2 is applied to the porous base material 2.

While the present embodiment has been described in conjunction with the use of the porous base material 2, the present invention is not limited thereto. Specifically, the present invention can be used for a base material which has an outer surface of uneven shape to which the application agent P2 is applied, even when the base material is not porous. In the application of the application agent P2 to the base material having the outer surface of uneven shape, the principle described in FIG. 8 results in the phenomenon in which bubbles come out. Thus, the solvent P1 is previously applied to the base material having the outer surface of uneven shape to remove the bubbles and then the application agent P2 is applied, thereby making it possible to suppress the production of bubble marks.

### Embodiment 2

Next, an application apparatus which is Embodiment 2 of the present invention will be described with reference to FIGS. 6 and 7. FIG. 6 is a schematic diagram showing the structure of the application apparatus in the present embodiment, and FIG. 7 is a schematic diagram showing an application step. In FIGS. 6 and 7, member identical to the members described in Embodiment 1 are designated with the same reference numerals and detailed description thereof is omitted. The following description is mainly focused on different points from Embodiment 1.

While the spray application apparatus 30 is used to apply the solvent P1 to the base material 2 in Embodiment 1, a gravure application apparatus 40 is used in the present embodiment instead of the spray application apparatus 30. In other words, two gravure application apparatuses 10 and 40 are used to apply a solvent P1 and an application agent P2 to a base material 2, respectively.

The gravure application apparatus 40 has an accommodating member 41 for accommodating the solvent P1, a gravure roll (roll member) 42 configured to transfer the solvent P1 to the base material 2, and a doctor blade 43 configured to wipe away any excess solvent P1 adhering to the gravure roll 42. The doctor blade 43 is held on a holder 44.

The gravure roll 42 and the doctor blade 43 have the same structures as those of the gravure roll 13 and the doctor blade 16 described in Embodiment 1, respectively. As shown in FIG. 7, the gravure roll 42 has an application region 42a in which a gravure pattern is carved in a circumferential direction and a non-application region 42b in which the gravure pattern is not carved in the circumferential direction.

Since the solvent P1 is also applied to the base material 2 before the application of the application agent P2 to the base material 2 in the present embodiment, the same effects as those in Embodiment 1 can be achieved. In addition, the gravure roll 42 is used to apply the solvent P1 in the present embodiment, so that the solvent P1 can be applied precisely to a particular region in the base material 2.

While the spray application apparatus 30 and the gravure application apparatus 40 are used to apply the solvent P1 to the base material 2 and the gravure application apparatus 10 is used to apply the application agent P2 to the base material 2 in Embodiments 1 and 2, the present invention is not limited thereto. In other words, the apparatus can have any structure as long as the solvent P1 and the application agent P2 can be applied to the base material 2.

For example, a spray application apparatus can be used for applying the application agent P2 to the base material 2. In addition, not only the abovementioned spray application apparatus and gravure application apparatus but also an application apparatus with another scheme can be used. Examples of the other scheme include a bar coater, a curtain coater, a knife coater, and a dip coater.

### DESCRIPTION OF REFERENCE NUMERALS

10: GRAVURE APPLICATION APPARATUS
13: GRAVURE ROLL
13a: APPLICATION REGION
13b: NON-APPLICATION REGION
2: BASE MATERIAL
30: SPRAY APPLICATION APPARATUS
31: SPRAY NOZZLE
32: SUPPLY TUBE
41: GRAVURE APPLICATION APPARATUS
P1: SOLVENT
P2: APPLICATION AGENT

1. An application apparatus used for manufacturing an electrode of a secondary battery; before a liquid application agent containing an inorganic oxide is applied to a porous electrode layer formed on a collector, the application apparatus applies a low-viscosity liquid having a lower viscosity than that of the application agent to the electrode layer.

2. The application apparatus according to claim 1, comprising a spray unit configured to spray the low-viscosity liquid to the electrode layer.

3. The application apparatus according to claim 1, comprising:
an accommodating member configured to accommodate the low-viscosity liquid;
a roll member having an application region and a non-application region, the application region applying the low-viscosity liquid in the accommodating member to the electrode layer through rotation operation, the non-application region not used for application of the low-viscosity liquid; and
a cover member being opposite to the non-application region of the roll member in the accommodating member and configured to prevent adhesion of the low-viscosity liquid to the non-application region.

4. The application apparatus according to claim 1, comprising:
an accommodating member configured to accommodate the application agent; and
a roll member configured to apply the application agent in the accommodating member to the electrode layer through rotation operation.

5. The application apparatus according to claim 1, wherein the low-viscosity liquid is a liquid having compatibility with the application agent.

6. The application apparatus according to claim 1, wherein an amount of the low-viscosity liquid applied to the electrode layer is equal to or larger than an amount filling a space portion included in the electrode layer.

7. The application apparatus according to claim 1, wherein the electrode layer is a negative electrode layer containing carbon.

8. The application apparatus according to claim 1, wherein the electrode layer has a width smaller than a width of the collector, and
wherein the low-viscosity liquid is applied to an entire surface of the electrode layer along the width of the electrode layer.

9. An application method used for manufacturing an electrode of a secondary battery, comprising:
a first step of applying an application agent containing an inorganic oxide to a porous electrode layer formed on a collector; and
a second step of applying a low-viscosity liquid having a lower viscosity than that of the application agent to the electrode layer before the first step.

10. The application method according to claim 9, wherein the low-viscosity liquid is a liquid having compatibility with the application agent.

11. The application method according to claim 9, wherein an amount of the low-viscosity liquid applied to the electrode layer is equal to or larger than an amount filling a space portion included in the electrode layer.

12. The application method according to claim 9, wherein the electrode layer is a negative electrode layer containing carbon.

13. The application method according to claim 9, wherein the electrode layer has a width smaller than a width of the collector, and
wherein, in the second step, the low-viscosity liquid is applied to an entire surface of the electrode layer along the width of the electrode layer.

14. The application apparatus according to claim 2, comprising:
an accommodating member configured to accommodate the application agent; and
a roll member configured to apply the application agent in the accommodating member to the electrode layer through rotation operation.

15. The application apparatus according to claim 3, comprising:
an accommodating member configured to accommodate the application agent; and
a roll member configured to apply the application agent in the accommodating member to the electrode layer through rotation operation.

16. The application apparatus according to claim 6, wherein the electrode layer is a negative electrode layer containing carbon.

17. The application apparatus according to claim 3, wherein the electrode layer has a width smaller than a width of the collector, and
wherein the low-viscosity liquid is applied to an entire surface of the electrode layer along the width of the electrode layer.

18. The application apparatus according to claim 15, wherein the electrode layer has a width smaller than a width of the collector, and
wherein the low-viscosity liquid is applied to an entire surface of the electrode layer along the width of the electrode layer.

19. The application method according to claim 11, wherein the electrode layer is a negative electrode layer containing carbon.
